(19) United States
(12) Patent Application Publication
(10) Pub. No.: US 2017/0017100 A1
(43) Pub. Date: Jan. 19, 2017

(54) SMART CURTAIN FILM

(71) Applicant: IRIS OPTRONICS INC., Tainan City (TW)

(72) Inventors: Chi-Chang LIAO, Tainan City (TW); Shu-Shien LIU, Tainan City (TW); Ku-Wei TSENG, Tainan City (TW)

(21) Appl. No.: 14/801,884

(22) Filed: Jul. 17, 2015

(51) Int. Cl. G02F 1/137; G02F 1/1343; G02F 1/1337; G02F 1/1339

(52) U.S. Cl. CPC G02F 1/137; G02F 1/1339; G02F 1/134309; G02F 1/1337

(57) ABSTRACT

A smart flexile smart curtain film is disclosed, a light transparency for the smart curtain film can be adjusted according to a voltage applied thereon. One of the embodiment shows that the smart curtain film is designed normal dark, and the transparency is related to the voltage applied. The greater voltage is applied the more transparent the smart curtain film displays. The smart curtain film is adaptive to be attached onto a surface of a window glass to form a smart window glass. During daytime, a person can adjust the transparency of the smart curtain to block some light beams from entering the room; and vice versa, during nighttime, a person can adjust the transparency of the smart curtain to block some light beams from exiting the room to keep one's privacy.

### BACKGROUND

Technical Field

The present invention relates to a smart curtain film. Especially relates to a smart curtain film of which the transparency can be adjusted.

Description of Related Art

FIGS. 1A˜1B Show a Prior Art.

FIG. 1A shows a traditional window which has a window glass 10 fitted within a frame 11.

FIG. 1B shows a traditional curtain made of clothes 12 configured in front of the window glass 10 for adjusting an amount of light beams entering the room. The traditional window glass 10 has a fixed transparency and can not be adjusted. The outside light beams pass through the traditional window glass 10 and enter the room without any change. A traditional curtain 12 made of clothes can be configured to control an amount of the light beams passing through; however the traditional curtain 12 is not easy to maintain.

It is desirable for a long time to develop a smart electronic window glass whereby the brightness of the window glass can be easily controlled.

### BRIEF DESCRIPTION OF THE DRAWINGS

FIGS. 1A˜1B show a prior art.

FIGS. 2A˜2D show light transparency adjusting according to the present invention.

FIGS. 3A˜3B show a roll of the smart curtain film according to the present invention.

FIGS. 4A˜4B show a first embodiment according to the present invention.

FIG. 5 shows a first structure for the cell wall according to line AA′ of FIG. 4B.

FIG. 6 shows a second structure for the cell wall according to the present invention.

FIGS. 7A˜8B show a structure for the top substrate according to the present invention.

FIGS. 9A˜9C show a second embodiment according to the present invention.

FIGS. 10˜13C show an application for the second embodiment according to the present invention.

FIGS. 14A˜14C show a modification embodiment according to the present invention.

FIGS. 15A˜15B show a second roll of the smart curtain film according to the present invention.

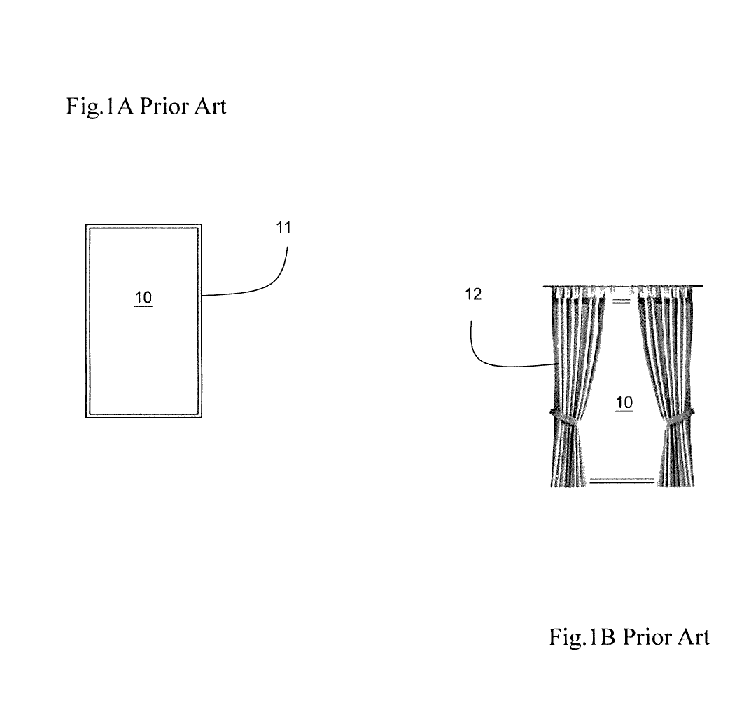

### DETAILED DESCRIPTION OF THE INVENTION

A smart window glass is disclosed whereby the brightness of the window glass can be adjusted according to a person's desire.

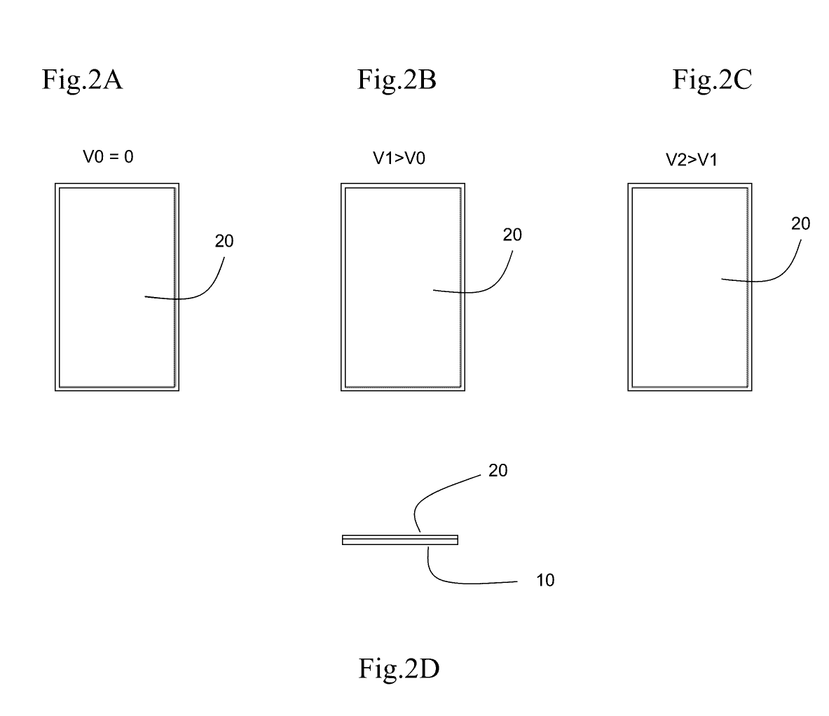

FIGS. 2A˜2D show light transparency adjusting according to the present invention.

FIG. 2A shows that a smart curtain film 20 is pasted on a top surface of a window glass 10 to form a smart window glass, see FIG. 2D, a section view of FIG. 2A.

FIG. 2A shows a normal black (or normal dark) for the smart window glass according to the present invention. The smart window glass shows a normal dark when no voltage (V0) is applied on two electrodes of the smart curtain film 20.

FIG. 2B shows a first transparency displayed for the smart window glass according to the present invention. FIG. 2B shows a brighter screen is displayed for the smart window glass when a first voltage (V1) higher than zero voltage (V0) is applied on two electrodes of the smart curtain film 20.

FIG. 2C shows a second transparency displayed for the smart window glass according to the present invention. FIG. 2B shows an even brighter screen is displayed for the smart window glass when a second voltage (V2) higher than the first voltage (V1) is applied on two electrodes of the smart curtain film 20.

FIG. 2D shows a section view of FIG. 2A˜2C.

FIG. 2D shows a piece of smart curtain film 20 is pasted on a top surface of a window glass 10 to make the window glass 10 smart.

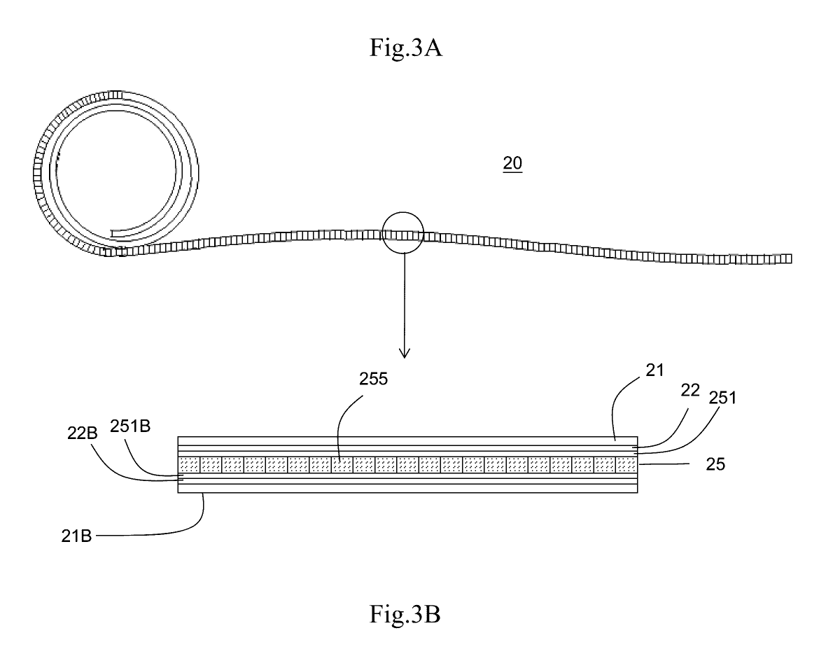

FIGS. 3A˜3B show a roll of the smart curtain film according to the present invention.

FIG. 3A shows a roll of the smart curtain film 20 is prepared and can be cut off randomly according to any patterns like a heart, a flower, a figure . . . etc.

FIG. 3B shows an enlarged view of a portion of the smart curtain film 20. The smart curtain film 20 comprises a flexible top substrate 21, a common top electrode 22 configured on a bottom surface of the flexible top substrate 21, and a top sealing layer 251 configured on a bottom surface of the top electrode 22. A plurality of independent cells 25 is configured on a bottom side of the top sealing layer 251; a bottom sealing layer 251B configured on a bottom of the cells 25. A common bottom electrode 22B is configured on a bottom of the bottom sealing layer 251B; and a flexible bottom substrate 21B is configured on a bottom of the common bottom electrode 22B.

Each of the cells 25 is formed by cell wall, top sealing layer 251 and bottom sealing layer 251B.

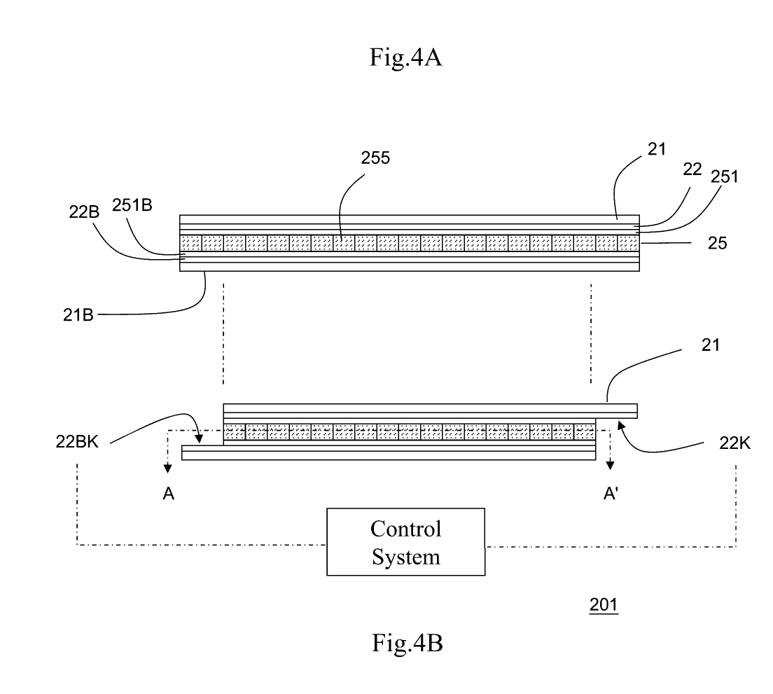

FIGS. 4A˜4B show a first embodiment according to the present invention.

FIG. 4A shows a piece of the smart curtain film 20 cut to prepare a first embodiment of the smart curtain film 201 of FIG. 4B. A liquid crystal recipe 255 comprising Cholesteric liquid crystal, Chiral dopant, and Monomer, is filled in each cell.

The cholesteric liquid crystal can be one of Nematic liquid crystal, for example E48 from Merk Co. The chiral dopant can be CB 15 from Merk Co., and the monomer can be one of BAB-6, 4-bis[6-(acryloyloxy)hexyloxy]biphenyl.

FIG. 4B shows a first embodiment of the smart curtain film 201. A portion of the common top electrode 22 is exposed and faces downwards as a top electrode contact 22K for electrically coupled to a control system; the top electrode contact 22K is exposed by a removal of the top sealing layer 251, the cells 25, the bottom sealing layer 251B, the bottom electrode 22B, and the bottom substrate 21B under the exposed top electrode contact 22K.

A portion of the common bottom electrode 22B is exposed in a left side and faces upwards as a bottom electrode contact 22BK for electrically couple to a control system; the bottom electrode contact 22BK is exposed by a removal of the bottom sealing layer 251B, the cells 25, the top sealing layer 251, the top electrode 22, and the top substrate 21 above the exposed bottom electrode contact 22BK.

The smart curtain film 201 of FIG. 4B displays a normal dark based on the recipe 255 filled in the cells 25 according to the present invention if no voltage is applied on the product. A light transparency from dark to white of the smart curtain film 201 is positively related to an amount of the voltage applied on the two electrodes 22, 22B of the smart curtain film 201. The recipe 255 comprises a weight percentage more than 95% of the Cholesteric liquid crystal, with chiral dopant, and weight percentage less than 5% of a monomer.

The electrodes 22, 22B is made of a material either Indian-Tin-Oxide (ITO) or silver paste, Poly(3,4-ethylenedioxythiophene) which also abbreviated as PEDOT, or other conductive paste material.

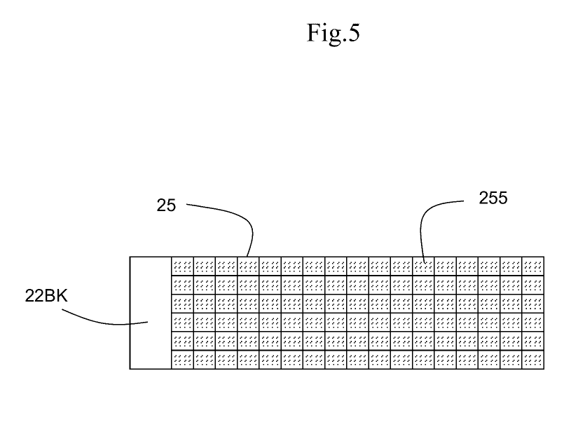

FIG. 5 shows a first structure for the cell wall according to the present invention.

FIG. 5 shows a section view according to line AA′ of FIG. 4B. Each of the cells 25 is formed by a square wall in a top view as an example.

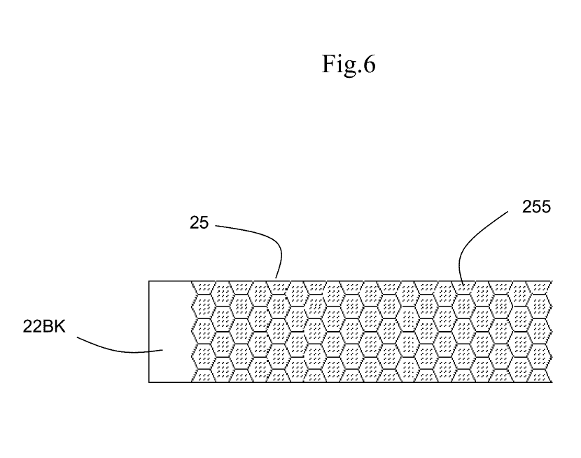

FIG. 6 shows a second structure for the cell wall according to the present invention.

FIG. 6 is similar to FIG. 5 but with different cell wall for the cell 25. FIG. 6 shows that each of the cells 25 is formed by a polygon wall in a top view as an example. Additional polygon wall such as triangle, pentagon, hexagon . . . etc., can also be designed for the cells 25.

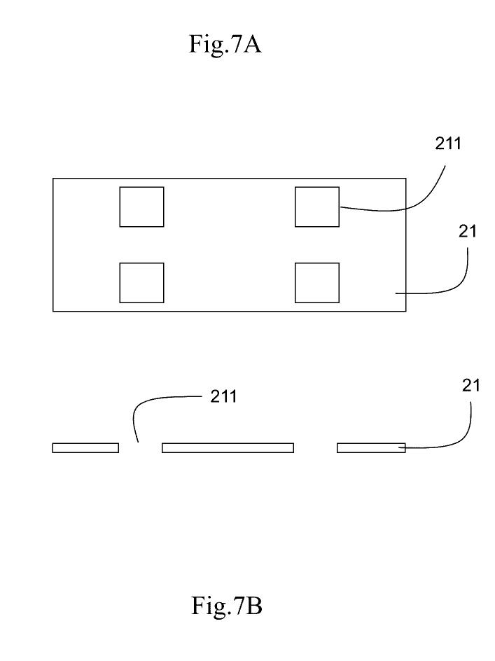

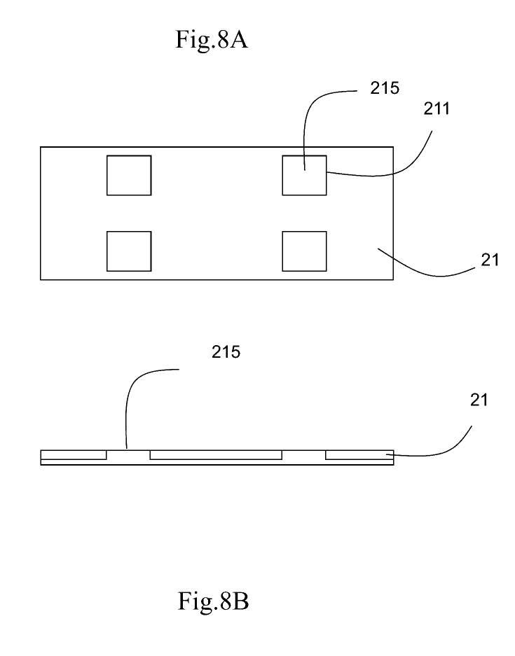

FIGS. 7A˜8B show a structure for the top substrate according to the present invention.

FIG. 7A shows a plurality of openings 211 formed on the top substrate 21. Each of the openings 211 passes through the top substrate 21.

FIG. 7B shows a section view of FIG. 7A where a plurality of openings 211 configured passing through the top substrate 21.

FIG. 8A shows that a silver paste 215 fills in the each opening 211.

FIG. 8B shows a section view of FIG. 8A where the silver paste 215 fills in the through openings 211 and extending to cover a bottom surface of the top substrate 21. The silver paste 215 functions as a common top electrode. The silver paste 215 within the opening 211 functions as an electrode contact.

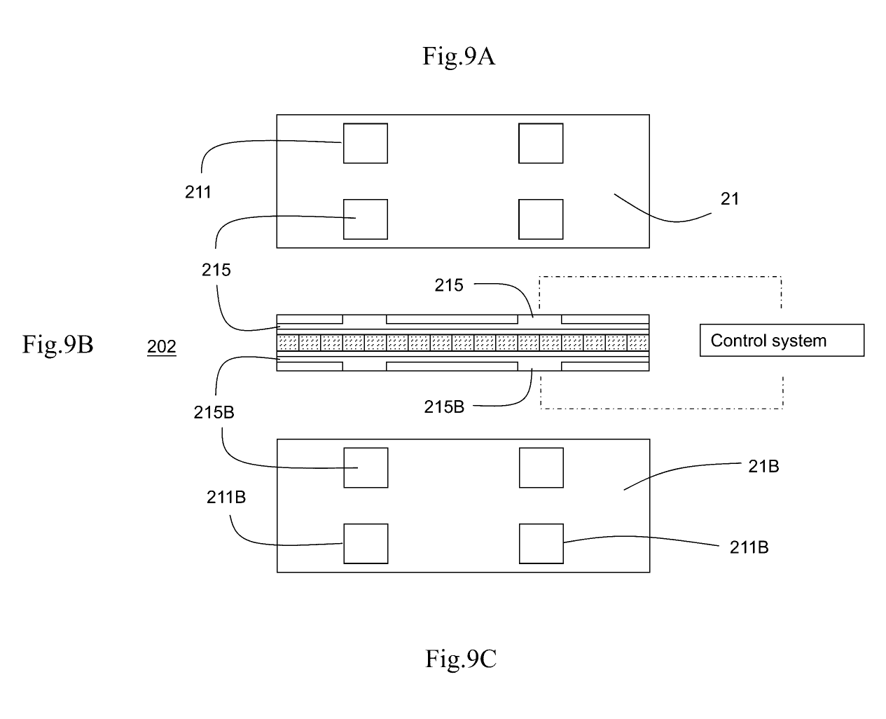

FIGS. 9A˜9C show a second embodiment according to the present invention.

FIG. 9A is the same as FIG. 8B, a top view of FIG. 9B.

FIG. 9B is the second embodiment for the smart curtain film 202 according to the present invention. FIG. 9B shows the silver paste 215, 215B electrically coupled to a control system for controlling the transparency of the smart curtain film 202.

FIG. 9C is a bottom view of FIG. 9B. FIG. 9C shows a bottom view of the bottom substrate 21B which is similar with the top substrate 21. A plurality of openings 211B formed passing through the bottom substrate 21B. Silver paste 215B fills in each of the openings 211B. The silver paste 215B extends to cover a top surface of the bottom substrate 21B (FIG. 9B). The silver paste 215B within the opening 211B functions as a bottom electrode contact for electrically coupling to a control system.

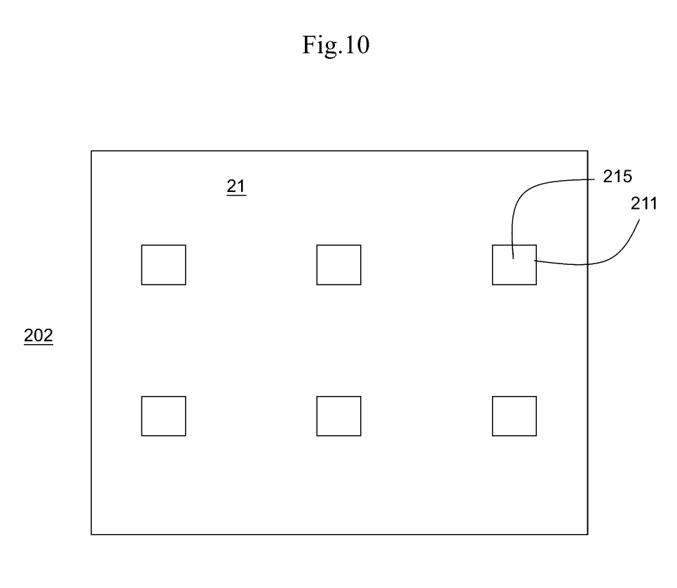

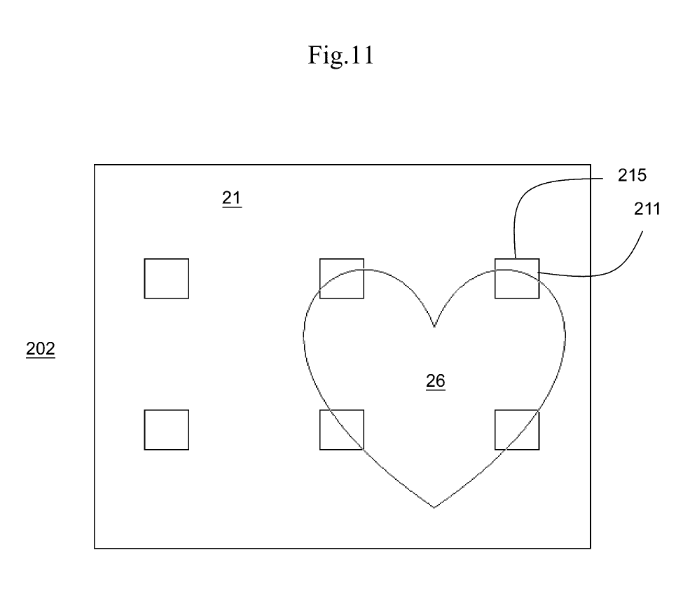

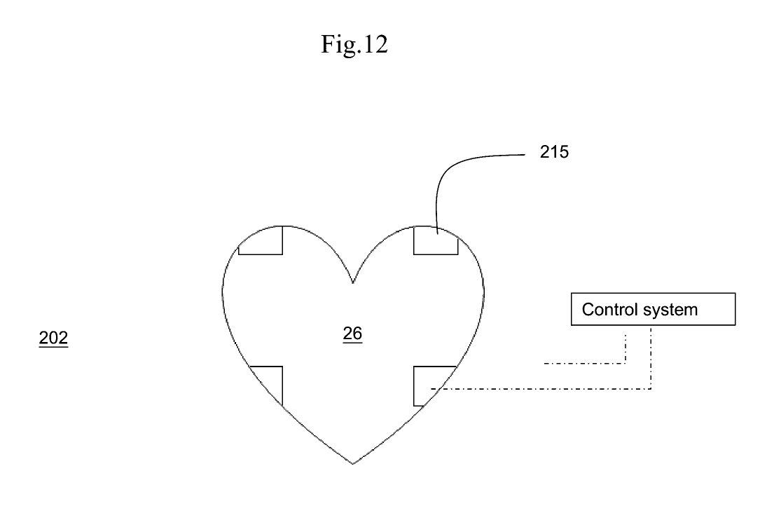

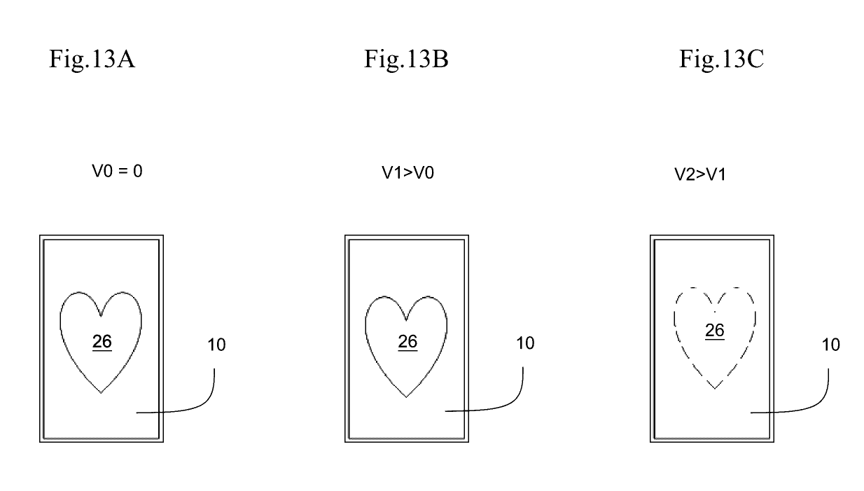

FIGS. 10˜13C show an application for the second embodiment according to the present invention.

FIG. 10 shows a top view of a piece of the smart curtain film 202 which shows a top substrate 21 with a plurality of openings 211 passing through, and silver paste 215 filled in the openings 211.

FIG. 11 shows a random cut can be performed. A heart pattern 26 is taken as an example ready to cut. The heart pattern 26 is prepared to cut off from the smart curtain film 202 with an area comprising at least one of the silver paste 215.

FIG. 12 shows the heart pattern 26 cut off from the smart curtain film 202 with the area comprising at least one of the silver paste 215. The exposed top silver paste 215 functions as a top electrode contact. An exposed bottom silver paste (not shown) functions as a bottom electrode contact. The top electrode contact and the bottom electrode contact are then electrically coupled to a control system. The transparency of the heart pattern is adjusted by the voltage applied.

FIGS. 13A˜13C show an application of the heart

FIGS. 13A˜13C show that a piece of the heart pattern 26 is pasted onto a surface of a window glass 10. In a sunny daytime, the window glass 10 can be used as a back light. The heart pattern 26 is made of the smart curtain film 202 which is normal dark as shown in FIG. 13A. A first transparency of FIG. 13B, lighter than FIG. 13A, is displayed when a first voltage is applied on the heart pattern 26. A second transparency of FIG. 13C, lighter than FIG. 13B, is displayed when a second voltage larger than the first voltage is applied on the heart pattern 26.

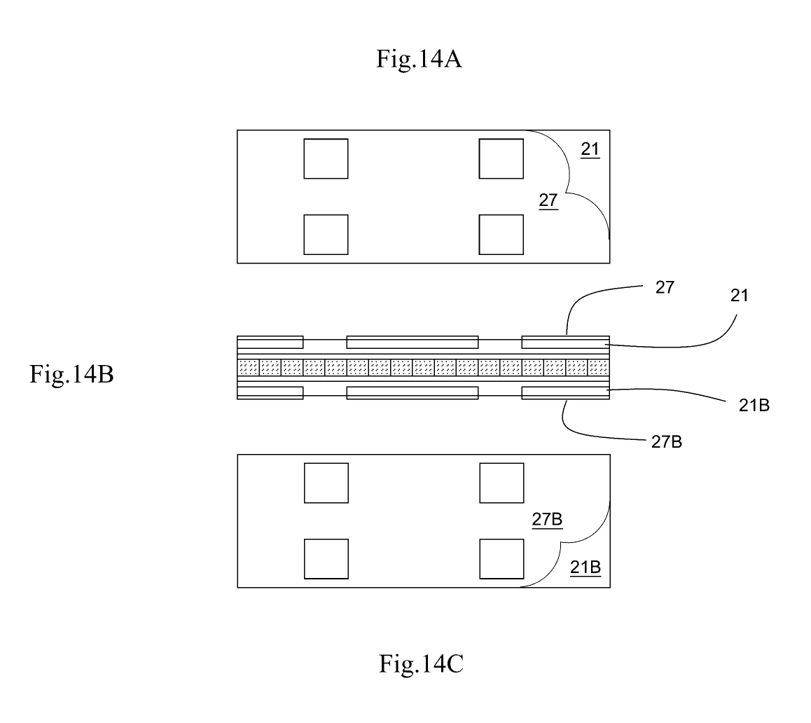

FIGS. 14A˜14C show a modification embodiment according to the present invention.

In order to prevent the hazardous from UV and/or IR light beams, a layer of UV-resistant film or IR-resistant film can be configured on a top surface of the top substrate or on a bottom surface of the bottom substrate.

FIG. 14A shows a layer of UV-resistant film or IR-resistant film 27 configured on a top surface of the top substrate 21.

FIG. 14B shows a section view of the modified embodiment. A layer of UV-resistant film or IR-resistant film 27 is configured on a top surface of the top substrate 21. Similarly, a layer of UV-resistant film or IR-resistant film 27B is configured on a bottom surface of the bottom substrate 21B.

FIG. 14C shows a bottom view of FIG. 14C. FIG. 14C shows a layer of UV-resistant film or IR-resistant film 27B configured on a bottom surface of the bottom substrate 21.

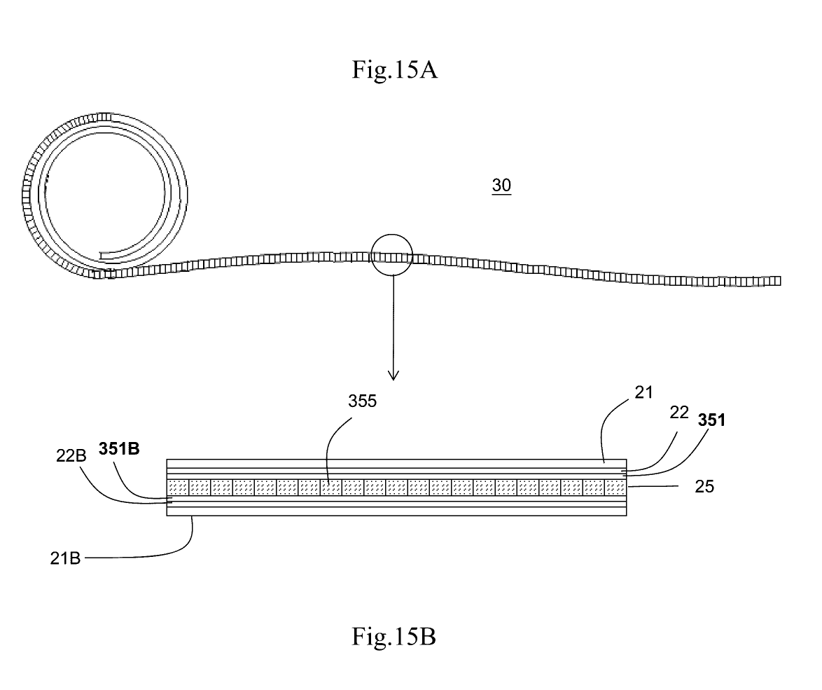

FIGS. 15A˜15B show a second roll of the smart curtain film according to the present invention.

FIG. 15A shows a second roll of the smart curtain film 30 is prepared and can be cut off randomly according to any patterns like a heart, a flower, a figure . . . etc.

FIG. 15B shows an enlarged view of a portion of the smart curtain film 30. The smart curtain film 30 is similar to the smart curtain film 20 only different in alignment layer. FIG. 15B shows a common top electrode 22 configured on a bottom surface of the flexible top substrate 21, and a top sealing alignment layer 351, such as polyimide, configured on a bottom surface of the top electrode 22. A plurality of independent cells 25 is configured on a bottom side of the top sealing alignment layer 351; a bottom sealing alignment layer 351B configured on a bottom of the cells 25. A common bottom electrode 22B is configured on a bottom of the bottom sealing alignment layer 351B; and a flexible bottom substrate 21B is configured on a bottom of the common bottom electrode 22B.

Each of the cells 25 is formed by cell wall, top sealing alignment layer 351, and bottom sealing alignment layer 351B.

The smart curtain film 30 of FIG. 15B displays a normal white based on the recipe 355 filled in the cells 25 according to the present invention if no voltage is applied on the product. A light transparency from white to dark of the smart curtain film 30 is positively related to an amount of the voltage applied on the two electrodes 22, 22B of the smart curtain film 30. The recipe 355 comprises a weight percentage more than 90% and less than 95% of the Cholesteric liquid crystal, with chiral dopant, and weight percentage less than 10% and larger than 5% of a monomer.

The cholesteric liquid crystal can be one of Nematic liquid crystal, for example E48 from Merk Co. The chiral dopant can be R1011 from Merk Co., and the monomer can be one of BAB-6, 4-bis[6-(acryloyloxy)hexyloxy]biphenyl.

While several embodiments have been described by way of example, it will be apparent to those skilled in the art that various modifications may be configured without departs from the spirit of the present invention. Such modifications are all within the scope of the present invention, as defined by the appended claims.

What is claimed is:

1. A smart curtain film, comprising:
a plurality of cells;
a liquid crystal recipe comprising Cholesteric liquid crystal, Chiral dopant, and Monomer, filled in each cell;
a top sealing layer, configured on a top of the cells;
a bottom sealing layer, configured on a bottom of the cells;
a common top electrode, configured on a top of the top sealing layer;
a common bottom electrode, configured on a bottom of the bottom sealing layer;
a top substrate, configured on a top of the common top electrode; and
a bottom substrate, configured on a bottom of the common bottom electrode; wherein
a normal dark is displayed, and
a light transparency from dark to white of the smart curtain film is positively related to an amount of a voltage applied on the common top electrode and the common bottom electrode.

2. A smart curtain film as claimed in claim 1, further comprising:
a portion of the common top electrode is exposed and faces downwards as a top electrode contact for electrically coupled to a control system; the top electrode contact is exposed by a removal of the top sealing layer, the cells, the bottom sealing layer, the bottom electrode, and the bottom substrate under the exposed top electrode contact.

3. A smart curtain film as claimed in claim 1, further comprising:
a portion of the common bottom electrode is exposed and faces upwards as a bottom electrode contact for electrically couple to a control system; the bottom electrode contact is exposed by a removal of the bottom sealing layer, the cells, the top sealing layer, the top electrode, and the top substrate above the exposed bottom electrode contact.

4. A smart curtain film as claimed in claim 1, wherein
one of the electrodes is made of a material selected from a group consisting of ITO, silver paste, and PEDOT.

5. A smart curtain film as claimed in claim 1, further comprising:
a plurality of top openings, configured passing through the top substrate; and
a first silver paste, filled in the top openings.

6. A smart curtain film as claimed in claim 1, further comprising:
a plurality of bottom openings, configured passing through the bottom substrate; and
a second silver paste, filled in the bottom openings.

7. A smart curtain film as claimed in claim 1, wherein
a section view of the cell has a shape selected from a group consisting of triangle, square, pentagon, hexagon, and polygon.

8. A smart curtain film as claimed in claim 1, further comprising:
a UV-resistant film, configured on one of a top surface of the top substrate and a bottom surface of the bottom substrate.

9. A smart curtain film as claimed in claim 1, further comprising:
an IR-resistant film, configured on one of a top surface of the top substrate and a bottom surface of the bottom substrate.

10. A smart window glass, comprising:
a smart curtain film as claimed in claim 1, configured on a top surface of the window glass.

11. A smart window glass as claimed in claim 10, further comprising:
a plurality of top openings, configured passing through the top substrate;
a first silver paste, filled in the top openings;
a plurality of bottom openings, configured passing through the bottom substrate; and
a second silver paste, filled in the bottom openings.

12. A smart curtain film, comprising:
a plurality of cells;
a liquid crystal recipe comprising Cholesteric liquid crystal, Chiral dopant, and Monomer, filled in each cell;
a top sealing alignment layer, configured on a top of the cells;
a common top electrode, configured on a top of the top sealing layer;
a top substrate, configured on a top of the common top electrode;
a bottom sealing alignment layer, configured on a bottom of the cells;
a common bottom electrode, configured on a bottom of the bottom sealing layer;
a bottom substrate, configured on a bottom of the common bottom electrode;
wherein
a normal white is displayed, and
a light transparency from white to dark of the smart curtain film is positively related to an amount of a voltage applied on the common top electrode and the common bottom electrode.

13. A smart curtain film as claimed in claim 12, further comprising:
a portion of the common top electrode is exposed and faces downwards as a top electrode contact for electrically coupled to a control system; the top electrode contact is exposed by a removal of the top sealing alignment layer, the cells, the bottom sealing alignment layer, the bottom electrode, and the bottom substrate under the exposed top electrode contact.

14. A smart curtain film as claimed in claim 12, further comprising:
a portion of the common bottom electrode is exposed and faces upwards as a bottom electrode contact for electrically couple to a control system; the bottom electrode contact is exposed by a removal of the bottom sealing alignment layer, the cells, the top sealing alignment layer, the top electrode, and the top substrate above the exposed bottom electrode contact.

15. A smart curtain film as claimed in claim 12, wherein
one of the electrodes is made of a material selected from a group consisting of ITO, silver paste, and PEDOT.

16. A smart curtain film as claimed in claim 12, further comprising:
a plurality of top openings, configured passing through the top substrate; and
a first silver paste, filled in the top openings.

17. A smart curtain film as claimed in claim 12, further comprising:
a plurality of bottom openings, configured passing through the bottom substrate; and
a second silver paste, filled in the bottom openings.

18. A smart curtain film as claimed in claim 12, wherein
a section view of the cell has a shape selected from a group consisting of triangle, square, pentagon, hexagon, and polygon.

19. A smart curtain film as claimed in claim 12, further comprising:
a UV-resistant film, configured on one of a top surface of the top substrate and a bottom surface of the bottom substrate.

20. A smart curtain film as claimed in claim 12, further comprising:
an IR-resistant film, configured on one of a top surface of the top substrate and a bottom surface of the bottom substrate.

21. A smart window glass, comprising:
a smart curtain film as claimed in claim 12, configured on a top surface of the window glass.

22. A smart window glass as claimed in claim 21, further comprising:
a plurality of top openings, configured passing through the top substrate;
a first silver paste, filled in the top openings;
a plurality of bottom openings, configured passing through the bottom substrate; and
a second silver paste, filled in the bottom openings.
